(19) United States
(12) Patent Application Publication
(10) Pub. No.: US 2022/0188835 A1
(43) Pub. Date: Jun. 16, 2022

(54) BLOCKCHAIN-BASED PERSONAL DATA MANAGEMENT SYSTEMS

(71) Applicant: Fixed Address Ltd., Bromley (GB)

(72) Inventors: Thabang Mashologu, Ottawa (CA); Themba Tembo, Bromley (GB)

(21) Appl. No.: 17/549,362

(22) Filed: Dec. 13, 2021

Related U.S. Application Data
(60) Provisional application No. 63/124,684, filed on Dec. 11, 2020.

(51) Int. Cl. G06Q 30/00; G06F 16/27; H04L 9/32; H04L 9/30; G06F 9/54

(52) U.S. Cl. CPC G06Q 30/01; G06F 16/27; H04L 2209/38; H04L 9/3073; G06F 9/547; H04L 9/3239

(57) ABSTRACT

Systems and methods for blockchain-based personal data management are described herein. A system can include a user management node to receive, from a user computing device, consent data indicating that a user consents to share personal data with an enterprise. The user management node can store, on a blockchain network, a consent transaction, a personal data update transaction, and an entry of a consent ledger corresponding to the consent data. The system can include an enterprise management node to validate, based on the entry of the consent ledger, that the user has consented to share the personal data with the enterprise and to transmit the encrypted personal data to an enterprise computing device. The system can include a notification node to transmit a message to the user computing device indicating that the personal data has been shared with the enterprise.

### CROSS-REFERENCE TO RELATED APPLICATION

The present application claims the benefit of U.S. Provisional Application No. 63/124,684, entitled “A SYSTEM AND METHOD FOR BLOCKCHAIN-BASED CONSENT AND PERSONAL DATA MANAGEMENT VIA MOBILE DEVICE,” filed on Dec. 11, 2020. The entire contents of the above-listed application are hereby incorporated by reference for all purposes.

### BACKGROUND

Organizations may require access to personal data from people with whom they interact, such as customers and business associates. For example, organizations need accurate contact information to properly address correspondence to their customers. Personal data can change over time as people move to different addresses, update their email addresses or phone numbers, etc. Organizations must continuously update stored personal data to ensure it remains accurate over time.

### BRIEF DESCRIPTION OF THE DRAWINGS

The present description will be understood more fully when viewed in conjunction with the accompanying drawings of various examples of systems and methods for blockchain-based personal data management. The description is not meant to limit the systems and methods to the specific examples. Rather, the specific examples depicted and described are provided for explanation and understanding of systems and methods for blockchain-based personal data management. Throughout the description, the drawings may be referred to as drawings, figures, and/or FIGs.

FIG. 1 illustrates a personal data management system, according to an embodiment.

FIG. 2 illustrates a device schematic for various devices used in the personal data management system of FIG. 1, according to an embodiment.

FIG. 3 illustrates a block diagram of a data model for blockchain-based personal data management, according to an embodiment.

FIG. 4 illustrates a block diagram of a system for blockchain-based personal data management, according to an embodiment.

FIG. 5 illustrates a method of registering a user to opt-in to sharing personal data with an enterprise, according to an embodiment.

FIG. 6 illustrates a method of updating personal data to be shared with an enterprise, according to an embodiment.

FIG. 7 illustrates a method of withdrawing consent for an enterprise to access personal data, according to an embodiment.

### DETAILED DESCRIPTION

Blockchain-based personal data management systems as disclosed herein will become better understood through a review of the following detailed description in conjunction with the figures. The detailed description and figures provide merely examples of the various embodiments of blockchain-based personal data management systems. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

Conventional techniques for maintaining users' personal data may include collecting the personal data directly from the users and storing the personal data in a database or other customer relationship management (CRM) tool. To keep users' personal data accurate over time, enterprises conventionally call or email users on a periodic basis and update their personal data accordingly. Enterprises may attempt to verify personal data of a user before the personal data becomes outdated, for example by asking the user to verify the personal data in real-time using a web form. Enterprises may also make periodic “data health checks” using software-based data cleansing tools, and may also employ third-party services to validate customer data.

Current techniques for maintaining personal data suffer from several drawbacks. Continuously reaching out to users and manually updating each user's data can be costly and time consuming, and may not be reliable even under the most favorable circumstances. Frequent changes to personal data can also pose problems for users. For example, during a typical move, a user may have to notify many different enterprises about his or her change of address. Similarly, upon obtaining a new credit card, a user must update credit card information stored by many entities, such as utilities providers, cable providers, cellular providers, retail websites, streaming services, retail clubs, and magazine subscription publishers, among others. Typically, the user must contact each enterprise individually to provide updated personal data, which can require a great deal of time and effort from the user.

Both users and enterprises can also experience problems when dealing with third-party data validation services, such as credit rating agencies. Typically, these third-party services store user data on their own premises or in another third-party server. As a result, users have no control over their data once it is in the possession of such a third-party service. Third-party services may therefore trade, sell, enrich, or enhance a user's personal data without the user's knowledge or consent. Enterprises who use third-party services to obtain or validate users' personal data also often must pay high prices for access to such data and yet have no way of guaranteeing that the data provided by the third-party services is accurate.

Enterprises also may have difficulty identifying and contacting potential new customers or users. For example, an enterprise may provide a product or service that is valuable to users of a particular demographic group or groups. Verifying and updating personal data for existing users can be challenging, but identifying potential new users may be even more difficult. Third-party data services (e.g., credit rating agencies) may be used as a source of information for identifying potential new users, but gaining access to such data can be prohibitively costly for an enterprise. In addition, the third-party service is the only other entity that benefits monetarily, while the potential customers themselves do not. There is no efficient way for an enterprise to identify new users or customers and to provide a financial incentive for the potential new users or customers to share their personal data with the enterprise.

Storing user personal data using the conventional techniques described above can also pose other risks to an enterprise. For example, data privacy and protection regulations, such as the General Data Protection Regulation (GDPR) and the Protection of Personal Information Act (POPIA), are becoming more common. Such regulations can require an enterprise to provide a user with transparency over how the enterprise uses personal data. Enterprises may also be required to allow a user to access stored personal data or to request erasure of their personal data at any time. Conventional techniques for managing users' personal data do not allow enterprises to comply with these requirements. Accordingly, enterprises who rely on the conventional personal data management techniques described above may face penalties for violating data privacy and protection regulations.

The various implementations of this disclosure address the shortcomings of current personal data management techniques described above. A personal data management system according to this disclosure can include a blockchain network for securely storing the most current consent status for a plurality of users. The consent status can include information indicating the enterprises that the user has consented to share personal data with. The blockchain network can also store references to personal data stored on a user's computing device. The blockchain network may not store the personal data itself, thereby allowing the user to maintain control of his or her personal data.

In some embodiments, the user may be provided with a mobile application configured to execute on the user's computing device, such as a mobile phone or tablet computing device. The mobile application can enable the user to quickly, easily, and securely make changes to saved personal data. The user can also use the mobile application to update their consent preferences with respect to any number of enterprises that the user wishes to grant access to the user's personal data, or to withdraw previously granted access. This can eliminate the need for the user to contact each enterprise individually to notify a plurality of enterprises when the user's personal data has changed. Thus, a user can save time and effort by eliminating the need to individually notify enterprises, organizations, and public entities of a change of address, credit card information, or other personal information. In addition, users can know which enterprises are using their personally identifiable information at any time. Because personal data can be stored on the mobile device in an encrypted form with the secure storage of encryption keys, personal data can also be protected from breaches.

The implementations of this disclosure also provide benefits for enterprises. For example, a system can allow an enterprise to request up-to-date contact information for a user at any time, and to receive a response to the request in real-time. In some embodiments, the system can facilitate automatic transmission of the response without any action from the user whose personal data is requested. Thus, an enterprise can obtain accurate, up-to-date personal data for a user so the enterprise can properly deliver products, services, and communications, without troubling the user with periodic requests for updated personal information or relying on the user taking action to respond.

The systems and methods of this disclosure can also help enterprises to efficiently comply with personal data protection regulations, such as GDPR and POPIA. For example, by storing personal data only on a user's computing device, the systems and methods of this disclosure enable the user to maintain control over his or her personal data. The user is also enabled to easily manage access to personal data by enterprises, for example by granting or withdrawing consent for an enterprise to access personal data at any time. Thus, the implementations of this disclosure can increase the level of trust between users and enterprises. In some embodiments, smart contracts can be created and stored on a blockchain network to govern how personal data is acquired and processed by enterprises. Such smart contracts can be represented by transaction data structures and blockchain ledger entries, as described further below.

The systems and methods of this disclosure also can allow an enterprise to easily identify potential new users or customers. For example, a personal data management system can allow an enterprise to request access to a potential new user's personal data. The request can be sent directly to the user (e.g., via a mobile application executing on the user's computing device), thereby eliminating the need for a third-party data provider, such as a credit rating agency, to act as an intermediary between the enterprise and the potential new user or customer. The enterprise may also be able to provide an incentive directly to the potential new user or customer to grant access to personal data. For example, the enterprise may offer a financial reward to a user if the user consents to sharing personal data with the enterprise. In some embodiments, information corresponding to the promised financial reward can be stored on the blockchain network, for example as a component of a smart contract described above. Thus, the enterprise can interact directly with the potential new user or customer to request access to the user's personal data without going through a third-part data service provider, and the potential new user or customer can be compensated financially for consenting to share personal data with the enterprise that made the request.

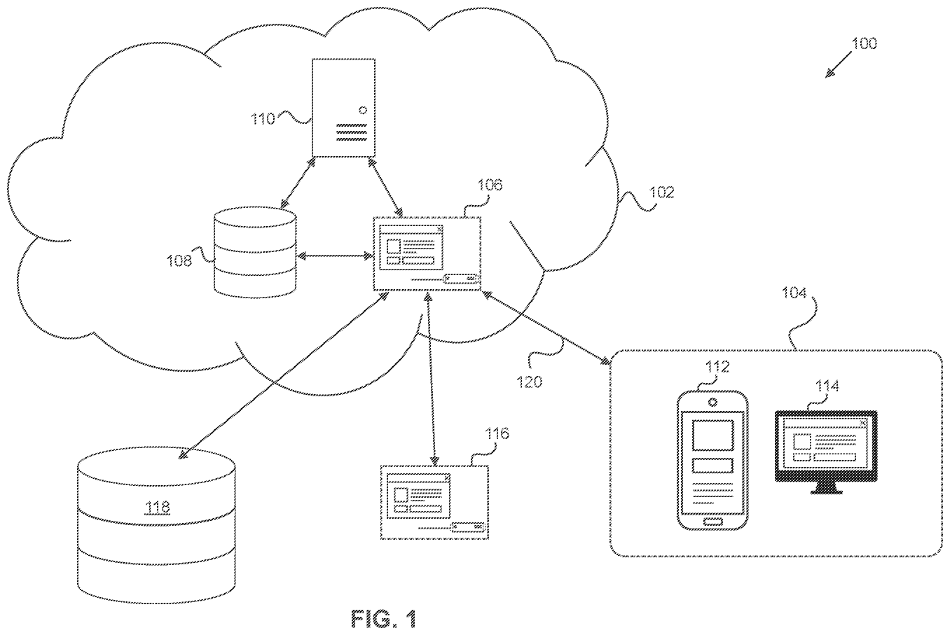

FIG. 1 illustrates a personal data management system 100, according to an embodiment. The personal data management system 100 includes internal and external data resources for managing personal data. The personal data management system 100 may result in reduced memory allocation at client devices and may conserve memory resources for application servers.

The personal data management system 100 may include a cloud-based data management system 102 and a user device 104. The cloud-based data management system 102 may include an application server 106, a database 108, and a data server 110. The user device 104 may include one or more devices associated with user profiles of the personal data management system 100, such as a smartphone 112 and/or a personal computer 114. The personal data management system 100 may include external resources such as an external application server 116 and/or an external database 118. The various elements of the personal data management system 100 may communicate via various communication links 120. An external resource may generally be considered a data resource owned and/or operated by an entity other than an entity that utilizes the cloud-based data management system 102 and/or the user device 104.

The personal data management system 100 may be web-based. The user device 104 may access the cloud-based data management system 102 via an online portal set up and/or managed by the application server 106. The personal data management system 100 may be implemented using a public Internet. The personal data management system 100 may be implemented using a private intranet. Elements of the personal data management system 100, such as the database 108 and/or the data server 110, may be physically housed at a location remote from an entity that owns and/or operates the personal data management system 100. For example, various elements of the personal data management system 100 may be physically housed at a public service provider such as a web services provider. Elements of the personal data management system 100 may be physically housed at a private location, such as at a location occupied by the entity that owns and/or operates the personal data management system 100.

The communication links 120 may be direct or indirect. A direct link may include a link between two devices where information is communicated from one device to the other without passing through an intermediary. For example, the direct link may include a Bluetooth™ connection, a Zigbee® connection, a Wifi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link may include a cable on a bus network. “Direct,” when used regarding the communication links 120, may refer to any of the aforementioned direct communication links.

An indirect link may include a link between two or more devices where data may pass through an intermediary, such as a router, before being received by an intended recipient of the data. For example, the indirect link may include a wireless fidelity (WiFi) connection where data is passed through a WiFi router, a cellular network connection where data is passed through a cellular network router, a wired network connection where devices are interconnected through hubs and/or routers, and so forth. The cellular network connection may be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long term evolution (LTE) standard, and so forth. “Indirect,” when used regarding the communication links 120, may refer to any of the aforementioned indirect communication links.

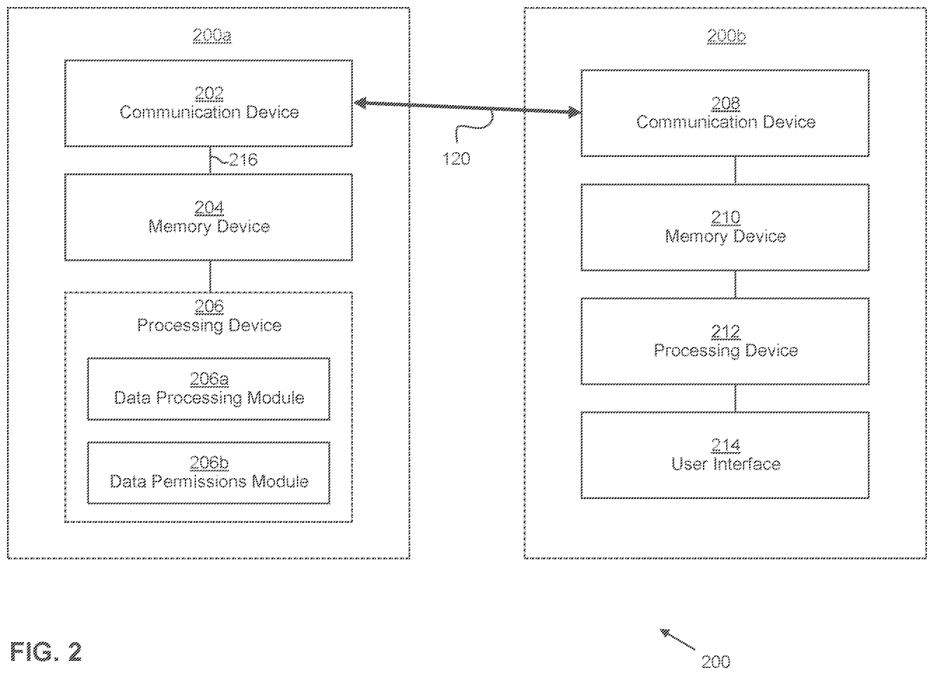

FIG. 2 illustrates a device schematic 200 for various devices used in the personal data management system 100, according to an embodiment. A server device 200a may moderate data communicated to a client device 200b based on data permissions to minimize memory resource allocation at the client device 200b.

The server device 200a may include a communication device 202, a memory device 204, and a processing device 206. The processing device 206 may include a data processing module 206a and a data permissions module 206b, where module refers to specific programming that governs how data is handled by the processing device 206. The client device 200b may include a communication device 208, a memory device 210, a processing device 212, and a user interface 214. Various hardware elements within the server device 200a and/or the client device 200b may be interconnected via a system bus 216. The system bus 216 may be and/or include a control bus, a data bus, and address bus, and so forth. The communication device 202 of the server device 200a may communicate with the communication device 208 of the client device 200b.

The data processing module 206a may handle inputs from the client device 200a. The data processing module 206a may cause data to be written and stored in the memory device 204 based on the inputs from the client device 200b. The data processing module 206a may receive data stored in the memory device 204 and output the data to the client device 200a via the communication device 202. The data permissions module 206b may determine, based on permissions data stored in the memory device, what data to output to the client device 200b and what format to output the data in (e.g. as a static variable, as a dynamic variable, and so forth). For example, a variable that is disabled for a particular user profile may be output as static. When the variable is enabled for the particular user profile, the variable may be output as dynamic.

The server device 200a may be representative of the cloud-based data management system 102. The server device 200a may be representative of the application server 106. The server device 200a may be representative of the data server 110. The server device 200a may be representative of the external application server 116. The memory device 204 may be representative of the database 108 and the processing device 206 may be representative of the data server 110. The memory device 204 may be representative of the external database 118 and the processing device 206 may be representative of the external application server 116. For example, the database 108 and/or the external database 118 may be implemented as a block of memory in the memory device 204. The memory device 204 may further store instructions that, when executed by the processing device 206, perform various functions with the data stored in the database 108 and/or the external database 118.

Similarly, the client device 200b may be representative of the user device 104. The client device 200b may be representative of the smartphone 112. The client device 200b may be representative of the personal computer 114. The memory device 210 may store application instructions that, when executed by the processing device 212, cause the client device 200b to perform various functions associated with the instructions, such as retrieving data, processing data, receiving input, processing input, transmitting data, and so forth.

As stated above, the server device 200a and the client device 200b may be representative of various devices of the personal data management system 100. Various of the elements of the personal data management system 100 may include data storage and/or processing capabilities. Such capabilities may be rendered by various electronics for processing and/or storing electronic signals. One or more of the devices in the personal data management system 100 may include a processing device. For example, the cloud-based data management system 102, the user device 104, the smartphone 112, the personal computer 114, the external application server 116, and/or the external database 118 may include a processing device. One or more of the devices in the personal data management system 100 may include a memory device. For example, the cloud-based data management system 102, the user device 104, the smartphone 112, the personal computer 114, the external application server 116, and/or the external database 118 may include the memory device.

The processing device may have volatile and/or persistent memory. The memory device may have volatile and/or persistent memory. The processing device may have volatile memory and the memory device may have persistent memory. Memory in the processing device may be allocated dynamically according to variables, variable states, static objects, and permissions associated with objects and variables in the personal data management system 100. Such memory allocation may be based on instructions stored in the memory device. Memory resources at a specific device may be conserved relative to other systems that do not associate variables and other object with permission data for the specific device.

The processing device may generate an output based on an input. For example, the processing device may receive an electronic and/or digital signal. The processing device may read the signal and perform one or more tasks with the signal, such as performing various functions with data in response to input received by the processing device. The processing device may read from the memory device information needed to perform the functions. For example, the processing device may update a variable from static to dynamic based on a received input and a rule stored as data on the memory device. The processing device may send an output signal to the memory device, and the memory device may store data according to the signal output by the processing device.

The processing device may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned specific devices, elements, and/or features of the processing device.

The memory device may be and/or include a computer processing unit register, a cache memory, a magnetic disk, an optical disk, a solid-state drive, and so forth. The memory device may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned specific devices, elements, and/or features of the memory device.

Various of the devices in the personal data management system 100 may include data communication capabilities. Such capabilities may be rendered by various electronics for transmitting and/or receiving electronic and/or electromagnetic signals. One or more of the devices in the personal data management system 100 may include a communication device, e.g., the communication device 202 and/or the communication device 208. For example, the cloud-based data management system 102, the user device 104, the smartphone 112, the personal computer 114, the application server 116, and/or the external database 118 may include a communication device.

The communication device may include, for example, a networking chip, one or more antennas, and/or one or more communication ports. The communication device may generate radio frequency (RF) signals and transmit the RF signals via one or more of the antennas. The communication device may receive and/or translate the RF signals. The communication device may transceive the RF signals. The RF signals may be broadcast and/or received by the antennas.

The communication device may generate electronic signals and transmit the RF signals via one or more of the communication ports. The communication device may receive the RF signals from one or more of the communication ports. The electronic signals may be transmitted to and/or from a communication hardline by the communication ports. The communication device may generate optical signals and transmit the optical signals to one or more of the communication ports. The communication device may receive the optical signals and/or may generate one or more digital signals based on the optical signals. The optical signals may be transmitted to and/or received from a communication hardline by the communication port, and/or the optical signals may be transmitted and/or received across open space by the networking device.

The communication device may include hardware and/or software for generating and communicating signals over a direct and/or indirect network communication link. For example, the communication component may include a USB port and a USB wire, and/or an RF antenna with Bluetooth™ programming installed on a processor, such as the processing component, coupled to the antenna. In another example, the communication component may include an RF antenna and programming installed on a processor, such as the processing device, for communicating over a Wifi and/or cellular network. As used herein, “communication device” “communication component,” and/or “communication unit” may be used generically herein to refer to any or all of the aforementioned elements and/or features of the communication component.

Various of the elements in the personal data management system 100 may be referred to as a “server.” Such elements may include a server device. The server device may include a physical server and/or a virtual server. For example, the server device may include one or more bare-metal servers. The bare-metal servers may be single-tenant servers or multiple tenant servers. In another example, the server device may include a bare metal server partitioned into two or more virtual servers. The virtual servers may include separate operating systems and/or applications from each other. In yet another example, the server device may include a virtual server distributed on a cluster of networked physical servers. The virtual servers may include an operating system and/or one or more applications installed on the virtual server and distributed across the cluster of networked physical servers. In yet another example, the server device may include more than one virtual server distributed across a cluster of networked physical servers.

The term server may refer to functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein, such as an application server, a processing server, a collaboration server, a scheduling server, and so forth may be instantiated in the same operating system and/or on the same server device. Separate servers may be instantiated in the same application or in different applications.

Various aspects of the systems described herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

Various of the devices in the personal data management system 100, including the server device 200a and/or the client device 200b, may include a user interface for outputting information in a format perceptible by a user and receiving input from the user, e.g., the user interface 214. The user interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The user interface may include an acoustic element such as a speaker, a microphone, and so forth. The user interface may include a button, a switch, a keyboard, a touch-sensitive surface, a touchscreen, a camera, a fingerprint scanner, and so forth. The touchscreen may include a resistive touchscreen, a capacitive touchscreen, and so forth.

Various methods are described below. The methods may be implemented by the data analysis system 100 and/or various elements of the data analysis system described above. For example, inputs indicated as being received in a method may be input at the client device 200b and/or received at the server device 200a. Determinations made in the methods may be outputs generated by the processing device 206 based on inputs stored in the memory device 204. Correlations performed in the methods may be executed by the correlation module 206a. Inference outputs may be generated by the inference module 206b. Key data and/or actionable data may be stored in the knowledge database 204b. Correlations between key data and actionable data may be stored in the knowledge database 204b. Outputs generated in the methods may be output to the output database 204c and/or the client device 200b. In general, data described in the methods may be stored and/or processed by various elements of the data analysis system 100.

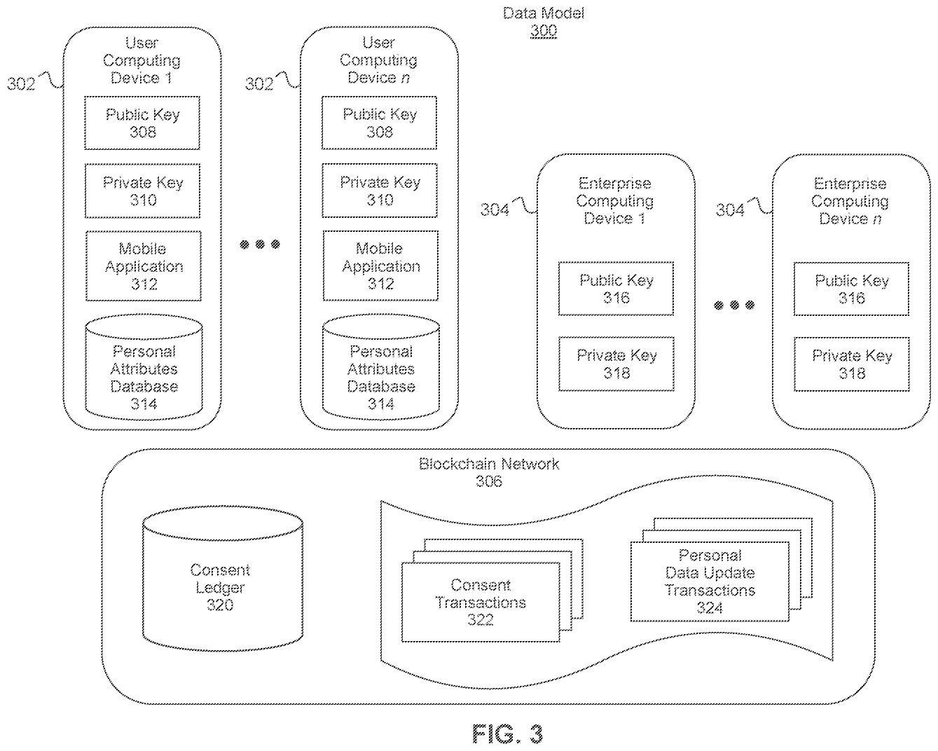

FIG. 3 illustrates a block diagram of a data model 300 for blockchain-based personal data management, according to an embodiment. The data model 300 depicts some of the entities that can be included in a system for managing personal data, as well as some of the data that can be generated, transmitted between, and stored by the entities. The data model 300 can include a one or more user computing devices 302. The data model 300 can include one or more enterprise computing devices 304. The data model data model 300 can also include a blockchain network 306.

In some embodiments, each user computing device 302 can be the same as or similar to the user device 104 described above in connection with FIG. 1. Each user computing device 302 can include a respective public key 308, private key 310, mobile application 312, and personal attributes database 314. The public key 308 and the private key 310 of each user computing device 302 can be cryptographic keys used to implement a public-private key encryption scheme. For example, the public key 308 of each user computing device 302 can be used to encrypt other information stored on the user computing device 302. In some embodiments, the encrypted information can include personal data of a respective user associated with the user computing device 302. Personal data can also be referred to in this disclosure as personal information or personally identifiable information. Personal data can include any data relating to an identity or a characteristic of the user of the user computing device 302. For example, personal data can include a first name, a last name, address information, a phone number, an email address, demographic information, an account number, a credit card number, and the like. The public key 308 can be used to encrypt the personal data, and the encrypted personal data can be stored in the personal attributes database 314.

The personal data can be stored in any type or form of data structure, such as an array, a linked list, a vector, and the like. An example format for a data structure that can be used to store personal data attributes is shown below in Table 1.

TABLE 1
Example Personal Attributes Data Structure

| Field | Description |
|---|---|
| Created Timestamp | The time when the user profile was created |
| User ID | The unique ID of the user |
| Personal Attributes | |
| Attribute Type | The type of personal attribute information, |
| | which can include first name, last name, |
| | address 1, address 2, apartment/suite, city, |
| | region, country, postal code, email address, |
| | phone, credit card number, etc. |
| Version | The version of the value for the specific |
| | attribute information, which can be used as a |
| | reference in the consent transaction that is |
| | recorded in the blockchain |
| Value | The actual value of the attribute |
| Last Modified Timestamp | The time when the value was last modified |

As shown in Table 1, a data structure for storing personal data can include a plurality of fields and at least one respective value for each field. The fields are shown in the left column of Table 1 and the descriptions of each field are shown in the right column of Table 1. Thus, a data structure for storing personal data can include a created timestamp field having a value that indicates a time at which a user profile was created for the user associated with the respective user computing device 302, a user ID field having a value (e.g., a string of alphanumeric characters) that uniquely identifies the user, and one or more personal attributes. Each personal attribute can include one or more attribute type fields with a respective value for each attribute type, a version field having a value that uniquely identifies a particular version of the personal attribute (e.g., to distinguish from earlier or later versions), a value field storing the actual value for the personal attribute, and a last modified timestamp having a value corresponding to the time when the personal attribute was last updated. It should be understood that the fields and descriptions shown in Table 1 are provided only as one example of a data structure for storing personal data. In some embodiments, other data structure formats may be used, which may include more, fewer, or different types of field-value pairs than are shown in Table 1.

Each user computing device 302 can include a mobile application 312. The mobile application 312 can be a software application configured to execute on the user computing device 302. The mobile application 312 can enable a user to add, delete, or modify personal data to be stored on the user computing device 302. In some embodiments, the mobile application 312 can be configured to receive inputs from the user and to generate or modify one or more personal attributes data structures such as the data structure shown and described above in connection with Table 1. The mobile application 312 can also be configured to cause the personal attributes database 314 to store the personal attributes data structures. In some embodiments, the mobile application 312 can encrypt the personal attributes data structures for secure storage, for example using the public key public key 308, prior to storing the personal attributes data structures in the personal attributes database 314. The personal attributes database 314 can be implemented using any type or form of memory device, as described above in FIG. 1 in connection with the databases 108 and 118. The mobile application 312 can also enable the user to receive requests and notification related to the user's personal data. For example, the mobile application 312 can be configured to display messages to the user and to receive inputs from the user corresponding to responses to the messages. In some embodiments, such a message can include a request from one of the enterprise computing devices 304 for access to the user's personal data. The request may also include an incentive, such as financial compensation, to be provided to the user if the user consents to allow the requesting enterprise to access the user's personal data. The user can respond to the request (e.g., accept or decline the request) by interacting with the mobile application 312.

In some embodiments, each enterprise computing device 304 can be the same as or similar to the application server 106 or the data server 110 described above in connection with FIG. 1. Each enterprise computing device 304 can be owned by or otherwise associated with a respective enterprise, such as a business or other organization. Each enterprise computing device 304 can include a respective public key 316 and private key 318. The public key 316 and the private key 318 of each enterprise computing device 304 can be cryptographic keys used to implement a public-private key encryption scheme. In some embodiments, the public key 316 and the private key 318 of an enterprise computing device 304 can be used together with the public key 308 and private key 310 of a user computing device 302 to allow information to be exchanged in an encrypted manner between the enterprise computing device 304 and the user computing device 302. Information may be transmitted either directly between a user computing device 302 and an enterprise computing device 304, or indirectly, for example by passing through at least one intermediary computing device.

The blockchain network 306 can be a collection of one or more blockchain nodes, each of which may be implanted by a respective computing device. The blockchain network 306 can include a consent ledger 320. The consent ledger 320 can be a set of data entries each indicating the most recent (i.e., current) status of a user's consent to share personal data with one or more enterprises. The blockchain network 306 can also include consent transactions 322. A consent transaction 322 can be a data record indicating an update in a consent status with respect to the accessibility to personal data of a particular user by a particular enterprise. A consent transaction 322 can be stored in any type or form of data structure, such as an array, a linked list, a vector, and the like. An example format for a data structure that can be used to implement a consent transaction 322 is shown below in Table 2.

TABLE 2
Example Consent Transaction Data Structure

| Field | Description |
|---|---|
| Transaction Timestamp | The time when the consent transaction is |
| | created |
| User ID | The unique ID of the user |
| Enterprise ID | The unique ID of the enterprise |
| Event Type | The event type of the transaction, such as opt- |
| | in, opt-out, update, revoke, etc. |
| Consent Attributes | |
| Attribute Type | The type of personal attribute information the |
| | user is updating, which can include first |
| | name, last name, address 1, address 2, |
| | apartment/suite, city, region, country, postal |
| | code, email address, phone, credit card |
| | number, etc. |
| Version | The version of the specific attribute |
| | information used for this consent transaction |

As shown in Table 2, a data structure for implementing a consent transaction 322 can include a plurality of fields and at least one respective value for each field. The fields are shown in the left column of Table 2 and the descriptions of each field are shown in the right column of Table 2. Thus, a consent transaction 322 data structure can include a transaction timestamp field having a value that indicates a time at which the consent transaction 322 was created, a user ID field having a value (e.g., a string of alphanumeric characters) that uniquely identifies the user who created the consent transaction 322, an enterprise ID field having a value (e.g., a string of alphanumeric characters) that uniquely identifies the enterprise for whom the user is granting, revoking, or otherwise modifying consent to access the user's personal data, an event type field having a value that corresponds to a type of the transaction (e.g., opt-in, opt-out, update, revoke, etc.), and one or more consent attributes. Each consent attribute can include one or more attribute type fields with a respective value for each attribute type and a version field having a value that uniquely identifies a particular version of the attribute (e.g., to distinguish from earlier or later versions). It should be understood that the fields and descriptions shown in Table 2 are provided only as one example of a data structure for implementing a consent transaction 322. In some embodiments, other data structure formats may be used, which may include more, fewer, or different types of field-value pairs than are shown in Table 2.

In some embodiments, a consent transaction data structure 322 can include information corresponding to a financial incentive to be provided to a user in connection with granting the consent represented by the consent transaction data structure 322. For example, an enterprise for which the user is granting consent to access personal data may offer a reward, such as financial compensation, to the user in return for the user granting access to the personal data. To maintain an accurate record of the promised reward and the user's acceptance of the offer for the reward, the consent transaction data structure 322 can include one or more field-value pairs relating to the reward. For example, the consent transaction data structure 322 can be configured to include an amount of the promised reward (e.g., a dollar amount), a time at which the reward is to be paid to the user, and a manner in which the reward is to be paid (e.g., a deposit into an account, a gift card redeemable for the promised amount, a discount on a product or service, etc.).

The blockchain network 306 can also include personal data update transactions 324. A personal data update transaction 324 can be a data record indicating an update (e.g., addition, deletion, modification, etc.) of one or more items of personal data of a particular user. A personal data update transaction 324 can be stored in any type or form of data structure, such as an array, a linked list, a vector, and the like. An example format for a data structure that can be used to implement a personal data update transaction 324 is shown below in Table 3.

TABLE 3
Example Personal Data Update Transaction Data Structure

| Field | Description |
|---|---|
| Transaction Timestamp | The time when the personal data update |
| | transaction is created |
| User ID | The unique ID of the user |
| Transaction Attributes | |
| Attribute Type | The type of personal attribute information the |
| | user is updating, which can include first |
| | name, last name, address 1, address 2, |
| | apartment/suite, city, region, country, postal |
| | code, email address, phone, credit card |
| | number, etc. |
| Version | The version of the specific attribute |
| | information used for this update transaction, |
| | which can be used as so that the attribute |
| | value does not need to be stored in the |
| | blockchain |

As shown in Table 3, a data structure for implementing a personal data update transaction 324 can include a plurality of fields and at least one respective value for each field. The fields are shown in the left column of Table 3 and the descriptions of each field are shown in the right column of Table 3. Thus, a personal data update transaction 324 data structure can include a transaction timestamp field having a value that indicates a time at which the personal data update transaction 324 was created, a user ID field having a value (e.g., a string of alphanumeric characters) that uniquely identifies the user who created the personal data update transaction 324, and one or more transaction attributes. Each transaction attribute can include one or more attribute type fields with a respective value for each attribute type and a version field having a value that uniquely identifies a particular version of the attribute (e.g., to distinguish from earlier or later versions). It should be understood that the fields and descriptions shown in Table 3 are provided only as one example of a data structure for implementing a personal data update transaction 324. In some embodiments, other data structure formats may be used, which may include more, fewer, or different types of field-value pairs than are shown in Table 3.

The consent transactions 322 and personal data update transactions 324 can be stored on the computing devices that form the nodes of the blockchain network 306. The nodes of the blockchain network 306 can therefore maintain historical records of the consent transactions 322 and the personal data update transactions 324 over time to create an auditable trail of a user's changes to personal data as well as changes to the user's consent status for enterprises to access the user's personal data.

Together, the data included in the consent ledger 320, the consent transaction 322, and the personal data update transaction 324 can implement a set of “smart contracts” between users and enterprises. Each smart contract can include a shared identity of the particular user and the particular enterprise that are parties to the smart contract, as well as a reference or pointer that indicates the user's personal data on the user computing device 302. Thus, the actual values of the user's personal data need not be stored on the blockchain network 306. With the consent of a user, the enterprise computing device 304 may access the user's personal data stored on the user computing device 302. The enterprise computing device 304 retrieve the personal data from the user computing device 302 in an encrypted format, and can read the user's personal data using the private key 318 to decrypt the personal data. The smart contracts implemented by the consent ledger 320, the consent transaction 322, and the personal data update transaction 324 can also include information corresponding to any financial reward promised by the enterprise to the user in return for the user granting the enterprise access to the user's personal data. For example, a smart contract can include information corresponding to the promised amount of such a financial reward and a manner in which the reward is to be delivered to the user. Thus, the smart contract can include a record of any promised reward that may have served as the basis for the user granting access to personal information by a particular enterprise.

According to the data model 300, in some embodiments changes to a user's personal data can be encrypted and stored only on the user computing device 302 associated with that user, thereby ensuring the authenticity of the personal data. When an enterprise wishes to access a user's most current personal data, the respective enterprise computing device 304 can uses the user's unique ID fetched from the personal data update transactions 324 to fetch the user's public key 308 to access the user's personal information. The enterprise computing device 304 can then use its private key 318 to decrypt the user's personal data. Thus, the user's personal data can be stored and shared securely using the data model 300.

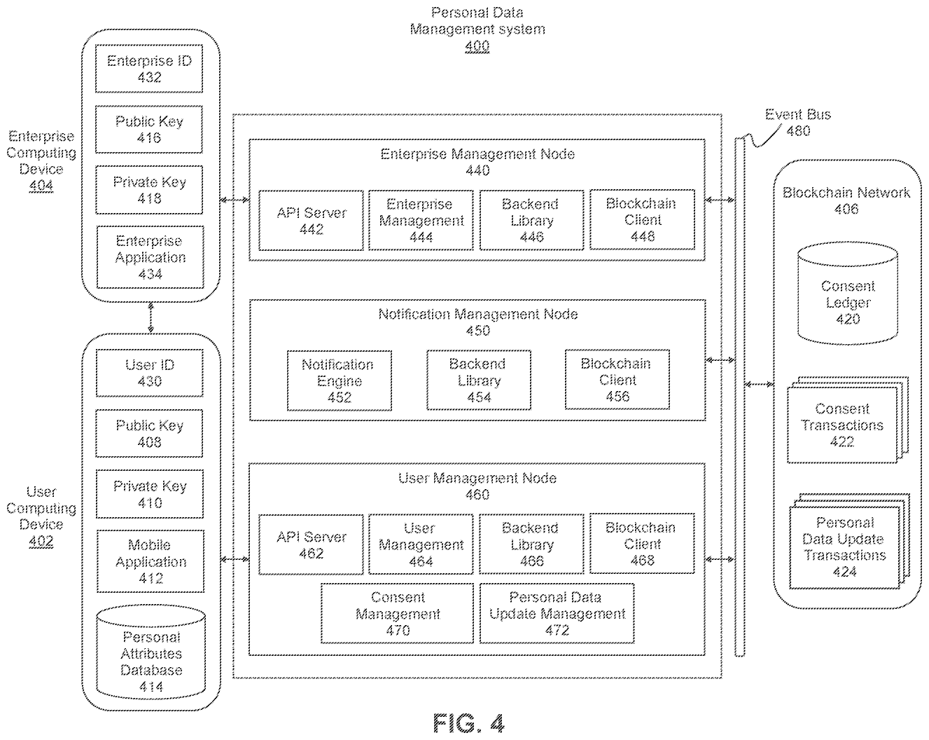

FIG. 4 illustrates a block diagram of a system 400 for blockchain-based personal data management, according to an embodiment. Some of the features in FIG. 4 may be the same as or similar to some of the features in the other FIGs. described herein as noted by the same and/or similar reference characters, unless expressly described otherwise. In some embodiments, the personal data management system 400 can be used to implement a data model such as the data model 300 described above in connection with FIG. 3. The personal data management system 400 includes an enterprise management node 440. The personal data management system 400 includes a 450. The personal data management system 400 includes a user management node 460. In some embodiments, the enterprise management node 440, the notification management node 450, and the user management node 460 may be implemented as separate computing devices that are communicatively linked with one another. In some other embodiments, the enterprise management node 440, the notification management node 450, and the user management node 460 may be implemented together on a single computing device.

The system personal data management system 400 also includes a blockchain network 406. The blockchain network 406 can be communicatively coupled with each of the enterprise management node 440, the notification management node 450, and the user management node 460 via an event bus 480. The blockchain network 406 includes a consent ledger 420. The consent ledger 420 can be a set of data entries each indicating the most recent (i.e., current) status of a user's consent to share personal data with one or more enterprises. The blockchain network 406 also stores consent transactions 422 and personal data update transactions 424. A consent transaction 422 can be a data record indicating an update in a consent status with respect to the accessibility to personal data of a particular user by a particular enterprise (e.g., an enterprise associated with the enterprise computing device 404). A personal data update transaction 424 can be a data record indicating an update (e.g., addition, deletion, modification, etc.) of one or more items of personal data of a particular user (e.g., a user of the user computing device 402).

The user computing device 402 includes a user identifier 430, which may be any information, such as an alphanumeric character string, that uniquely identifies a user of the user computing device 402 from among a plurality of different users of other user computing devices that may also interface with the personal data management system 400. In some embodiments, the user identifier 430 can be assigned to the user computing device 402 by a component of the personal data management system 400, such as the user management node 460. The user computing device 402 can include a personal attributes database 414, which can be used to store the user's personal data. The user computing device 402 includes a public key 408 and a private key 410. The public key 408 and the private key 410 can be used to encrypt and decrypt personal data to be stored in the personal attributes database 414 or transmitted to another computing device in a secure fashion. The user computing device 402 also includes a mobile application 412. The mobile application 412 can be a software application configured to execute on the user computing device 402. The mobile application 412 can allow the user to add, delete, or modify personal data, and to select consent preferences for sharing the personal data with one or more enterprises, such as an enterprise that is associated with the enterprise computing device 404.

The enterprise computing device 404 can include an enterprise identifier 432. The enterprise identifier 432 may be any information, such as an alphanumeric character string, that uniquely identifies an enterprise associated with the enterprise computing device 404 from among a plurality of different enterprises of other enterprise computing devices that may also interface with the personal data management system 400. In some embodiments, the enterprise identifier 432 can be assigned to the enterprise computing device 404 by a component of the personal data management system 400, such as the enterprise management node 440. The enterprise computing device 404 can include a public key 416 and a private key 418. The public key 416 and the private key 418 can be used together with the private key 410 and the mobile application 412 of the user computing device 402 to share encrypted data between the user computing device 402 and the enterprise computing device 404. The enterprise computing device 404 can include an enterprise application 434. In some embodiments, the enterprise application 434 can be customer relationship management (CRM) software application configured to execute on the enterprise computing device 404. The enterprise computing device 404 can be used to collect and store personal data from users who have given consent for the enterprise computing device 404 to access their personal data.

The enterprise management node 440 can be communicatively linked with the enterprise computing device 404. The enterprise management node 440 can include an application programming interface (API) server 442 that may facilitate communication between the enterprise management node 440 and the enterprise computing device 404. For example, the API server 442 may transmit API calls and receive responses to such calls from the enterprise application 434 that executes on the enterprise computing device 404, thereby allowing the API server 442 to read or write data to or from the enterprise application 434. The API server 442 can implement an API that is selected to be compatible with the enterprise application 434. In some embodiments, the API implemented by the API server 442 can be a representational state transfer (REST) API.

The enterprise management node 440 can include an enterprise management component 444. The enterprise management component 444 can control operation of the enterprise management node 440 and its components, as well as interactions between the enterprise management node 440 and the enterprise computing device 404. The enterprise management node 440 can include a backend library 446 and a blockchain client 448. The backend library 446 and the blockchain client 448 can enable the enterprise management node 440 to communicate with the blockchain network 406. For example, the backend library 446 can include reusable segments of code or other computer instructions configured to read or write data to or from the blockchain network 406. The blockchain client 448 can transmit and receive information, such as instructions from the backend library 446, to and from the blockchain network 406. The components of the enterprise management node 440, including the API server 442, the enterprise management component 444, the backend library 446, and the blockchain client 448 can each be implemented as hardware, software, or a combination of hardware and software configured to enable the functionality of the components as described in this disclosure.

The user management node 460 can be communicatively linked with the user computing device 402. The user management node 460 can include an API server 462 that may facilitate communication between the user management node 460 and the user computing device 402. For example, the API server 462 may transmit API calls and receive responses to such calls from the mobile application 412 that executes on the user computing device 402, thereby allowing the API server 462 to read or write data to or from the mobile application 412. The API server 462 can implement an API that is selected to be compatible with the mobile application 412. In some embodiments, the API implemented by the API server 462 can be a REST API.

The user management node 460 can include a user management component 464. The user management component 464 can control operation of the user management node 460 and its components, as well as interactions between the user management node 460 and the user computing device 402. The user management node 460 can include a backend library 466 and a blockchain client 468. The backend library 466 and the blockchain client 468 can enable the user management node 460 to communicate with the blockchain network 406. For example, the backend library 466 can include reusable segments of code or other computer instructions configured to read or write data to or from the blockchain network 406. The blockchain client 468 can transmit and receive information, such as instructions from the backend library 466, to and from the blockchain network 406.

The user management node 460 can include a consent management component 470. The consent management component 470 can be configured to validate a user's consent for sharing personal data updates. To validate a user's consent, the consent management component 470 can query the consent ledger 420 of the blockchain network 406 to determine whether the consent ledger 420 contains an entry indicating that a particular user has consented to share personal data with a particular enterprise. The user management node 460 can also include a personal data update management component 472 that can be configured to validate updates to a user's personal data. For example, the personal data update management component 472 can query the personal data update transactions 424 stored on the blockchain network 406 to confirm whether a user has updated personal data, as well as the details regarding the updated personal data (e.g., a time at which the personal data was updated, the types of personal data that were updated, etc.).

The event bus 480 can be a set of one or more communication links configured to enable data transmissions to and from each of the enterprise management node 440, the notification management node 450, the user management node 460, and the blockchain network 406. In some embodiments, the enterprise management node 440 and the user management node 460, together with the event bus 480, can facilitate communication between the enterprise computing device 404 and the user computing device 402. For example, the enterprise computing device 404 can transmit information (e.g., a request for updated personal data) to the user computing device 402 via a communication path that flows from the enterprise computing device 404 to the enterprise management node 440, from the enterprise management node 440 to the user management node 460 via the event bus 480, and then from the user management node 460 to the user computing device 402. Similarly, the user computing device 402 can transmit information (e.g., encrypted personal data) to the enterprise computing device 404 via communication path that flows from the user computing device 402 to the user management node 460, from the user management node 460 to the enterprise management node 440 via the event bus 480, and then from the enterprise management node 440 to the enterprise computing device 404. In some embodiments, the enterprise computing device 404 and the user computing device 402 can also be configured to share information via a direct communication link.

In some embodiments, the personal data management system 400 can enable an enterprise to broadcast a request for consent to share personal data to any user or users whose personal data matches a target profile selected by the enterprise. For example, the enterprise can select a target profile corresponding to any demographic information that may fall within the enterprise's target audience. Such demographic information can include an age range, a geographic area, etc. The enterprise computing device 404 can request that the personal data management system 400 identify all users who fall within the target profile selected by the enterprise. The personal data management system 400 can identify the users who meet the target profile according to the user's personal data. The personal data management system 400 can transmit a request to the user computing device 402 based on a determination that the user of the user computing device 402 is in the enterprise's target audience.

In some embodiments, the request can be displayed to on a display screen of the user computing device 402 via the mobile application 412. The request can also include a financial reward promised to the user in return for the user consenting to allow the enterprise to access the user's personal data. The user may either accept or deny the request, for example via an interaction with the mobile application 412. If the user agrees, a consent transaction 422 corresponding to the user's acceptance can be generated and stored on the blockchain network 406, as described above. The consent transaction may also store a record of the promised financial reward, for example as part of a smart contract between the user and the enterprise. Thus, the blockchain network 406 can be used to securely monetize the personal data of a user in a way that directly benefits the user (e.g., with financial compensation to the user for allowing access to the personal data). The enterprise can also benefit from the system by gaining access directly to reliable personal data of a user without having to use and pay for a third-part data service provider. The system personal data management system 400 can therefore allow an enterprise to engage directly with potential new users and customers who are in their target audience.

The notification management node 450 can include a notification engine 452. The notification engine 452 can be configured to transmit notifications to the user computing device 402 and the enterprise computing device 404. The notifications can relate to any changes or updates to a consent status or a personal data attribute of a user. For example, the notification engine 452 can notify the enterprise computing device 404 and the user computing device 402 of user consent opt-in/opt-out transactions and personal data update transactions. The notification management node 450 can include a backend library 454 and a blockchain client 456. The backend library 454 and the blockchain client 456 can enable the notification management node 450 to communicate with the blockchain network 406. For example, the backend library 454 can include reusable segments of code or other computer instructions configured to read or write data to or from the blockchain network 406. The blockchain client 456 can transmit and receive information, such as instructions from the backend library 454, to and from the blockchain network 406.

The various components of the user management node 460, including the API server 462, the user management component 464, the backend library 466, the blockchain client 468, the consent management component 470, and the personal data update management component 472 can each be implemented as hardware, software, or a combination of hardware and software configured to enable the functionality of the components as described in this disclosure.

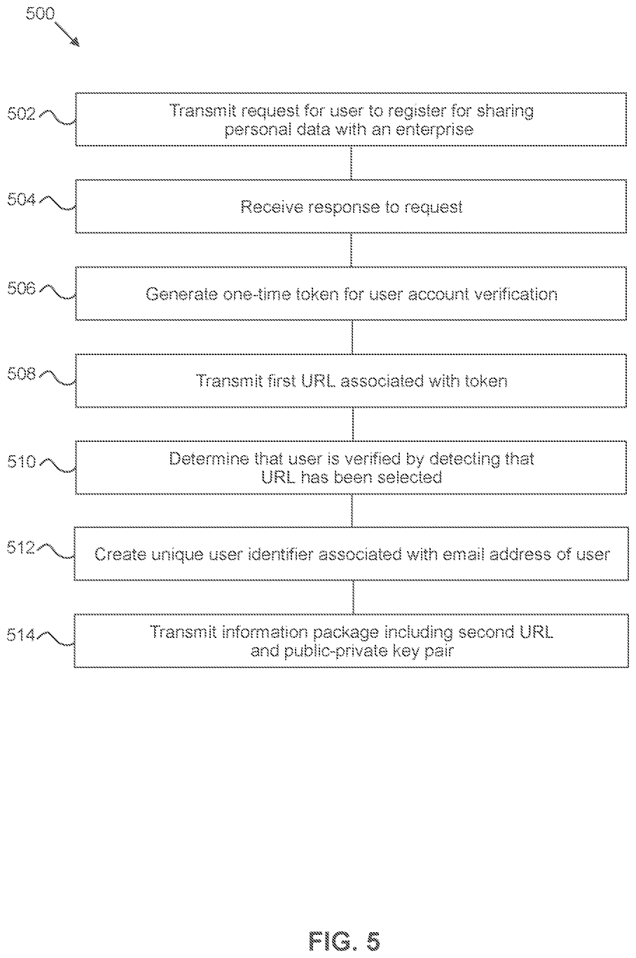

FIG. 5 illustrates a method 500 of registering a user to opt-in to sharing personal data with an enterprise, according to an embodiment. In some implementations, the method 500 can be performed by a system such as the personal data management system 400 described above in connection with FIG. 4. In brief overview, the method 500 can include transmitting a request for a user to register for sharing personal data with an enterprise (block 502), receiving a response to the request (block 504), and generating a one-time token for user account verification (block 506). The method 500 can include transmitting a first uniform resource locator (URL) associated with the one-time token (block 508) and determining that the user is verified by detecting that the URL has been selected (block 510). The method 500 can also include creating a unique user identifier associated with an email address of the user (block 512) and transmitting an information package including a second URL and a public-private key pair (block 514).

Referring again to FIG. 5, and in greater detail, the method 500 can include transmitting a request for a user to register for sharing personal data with an enterprise (block 502). In some embodiments, the request can be transmitted by a user management node similar to the user management node 460 of FIG. 4. The request can be received by a user computing device, such as the user computing device 402 of FIG. 4. In some embodiments, the request can be transmitted in an email message to be viewed on the user computing device.

The method 500 can include receiving a response to the request (block 504). The response can be received, for example, by the user management node. In some embodiments, the response can be received as a result of the user selecting a hyperlink included in the request transmitted in block 502. The response can indicate that the user wishes to register for sharing the personal data with the enterprise.

The method 500 can include generating a one-time token for user account verification (block 506). The one-time token can be a software object that grants permission for the user to register for an account with the personal data management system. The one-time token can include an expiration time after which the one-time token becomes invalid. The one-time token can become valid upon completion of an action by the user, such as visiting a website associated with the one-time token.

The method 500 can include transmitting a first uniform resource locator (URL) associated with the one-time token (block 508). The URL can correspond to a website that is associated with the one-time token, such as a registration website that the user can visit during a time period in which the one-time token remains valid. The URL can be transmitted to the user computing device, for example, within the body of an email.

The method 500 can include determining that the user is verified by detecting that the URL has been selected (block 510). The user may select the URL using a touchscreen interface or other pointing component of the user computing device. The personal data management system can detect that the URL has been selected, for example, by detecting the initiation of a user session that is triggered when the user first visits website corresponding to the URL.

The method 500 can include creating a unique user identifier associated with an email address of the user (block 512). The unique user identifier can be any information that uniquely identifies the user from among a group of users. The user identifier can be an alphanumeric character string. The user identifier can be generated in a manner that protects the user's actual identity, for example by not including the user's name or other personally identifiable information. In some embodiments, the user identifier can be created using a hashing function. For example, the user's email address can be manipulated with a hashing function to generate the unique user identifier.

The method 500 can include transmitting an information package including a second URL and a public-private key pair (block 514). The information package can be included, for example, as part of an email or as an attachment to an email. The second URL can correspond to a download link for a mobile application. For example, the user can visit a website associated with the second URL and can download the mobile application from the second website. The mobile application can be installed on the user's computing device. The public-private key pair can include a public key and a private key to be stored on the user computing device and used to implement a public-private key encryption scheme that can enable secure storage and transmission of the user's personal data.

In some embodiments, the method 500 can also include receiving, by the personal data management system from the user computing device, consent data from the user computing device. The consent data can indicate that the user consents to share the personal data with an enterprise. The consent data can be transmitted, for example, by the mobile application that executes on the user computing device to the personal data management system. In some embodiments, the consent data can be used to generate a consent transaction and/or a personal data update transaction. Each of the consent transaction, the personal data update transaction, and the entry of the consent ledger can include the unique user identifier. The method 500 can also include storing the consent transaction, the personal data update transaction, and/or an entry of a consent ledger on a blockchain network, such as the blockchain network 406 of FIG. 4.

In some embodiments, the method 500 can include generating the consent transaction to include a respective value for each of a plurality of fields. For example, the fields can include any of the fields shown and described above in connection with the example consent transaction data structure of Table 2. In some embodiments, the method 500 can include generating, by the personal data management system, the personal data update transaction including a respective value for each of a plurality of fields, which can include any of the fields shown and described above in connection with the example personal data update transaction data structure of Table 3.

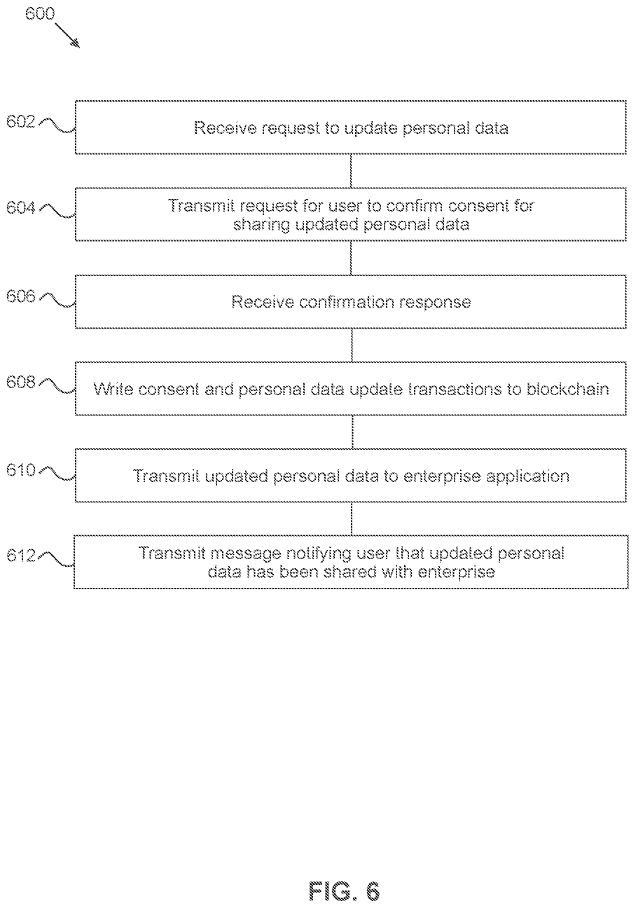

FIG. 6 illustrates a method 600 of updating personal data to be shared with an enterprise, according to an embodiment. In some implementations, the method 600 can be performed by a system such as the personal data management system 400 described above in connection with FIG. 4. In brief overview, the method 600 can include receiving a request to update personal data (block 602), transmitting a request for the user to confirm consent for sharing the updated personal data (block 604), and receiving a confirmation response (block 606). The method 600 can also include writing consent data and personal data update transactions to a blockchain (block 608), transmitting the updated personal data to an enterprise application (block 610), and transmitting a message notifying the user that the updated personal data has been shared with the enterprise (block 612).

Referring again to FIG. 6, and in greater detail, the method 600 can include receiving a request to update personal data (block 602). The request can be received by the personal data management system, for example, from a user computing device. In some embodiments, the user can interact with a mobile application executing on the user computing device to indicate that the user wishes to add or update personal data. The mobile application may be configured to generate the request to update the personal data and to transmit the request to the personal data management system, based on the user interaction. In some embodiments, the request to update the personal data can be formatted as one or more application programming interface (API) requests.

The method 600 can include transmitting a request for the user to confirm consent for the sharing the updated personal data (block 604). The personal data management system can transmit the confirmation request to the user computing device to cause the mobile application executing on the user computing device to display information corresponding to the confirmation request. The confirmation request can help to ensure that the request to update personal data was not sent to the personal data management system inadvertently.

The method 600 can include receiving a confirmation response (block 606). The confirmation response can be any information that confirms that the user intends to update the personal data. In some embodiments, the user can interact with the mobile application executing on the user computing device to confirm that the user wishes to update the personal data. The mobile application may be configured to generate the confirmation response and to transmit the confirmation response to the personal data management system, based on the user interaction. In some embodiments, the confirmation response can be formatted as one or more application programming interface (API) requests.

The method 600 can also include writing consent data and personal data update transactions to a blockchain (block 608). The personal data management system can generate the consent data and personal data update transactions to include information corresponding to the updated personal information and consent status selected by the user. In some embodiments, the consent transaction can be a data structure formatted in a manner similar to or the same as the example consent transaction data structure of Table 2. In some embodiments, the personal data update transaction can be a data structure formatted in a manner similar to or the same as the example personal data update transaction data structure of Table 3.

The method 600 can include transmitting the updated personal data to an enterprise application (block 610). The personal data can be transmitted to the enterprise application executing on an enterprise computing device in an encrypted format. The encrypted data can then be decrypted on the enterprise computing device. In some embodiments, the updated personal data can be sent to the enterprise application executing on the enterprise computing device via the personal data management system. For example, the personal data management system can retrieve the updated personal data from the user computing device and can forward the updated personal data to the enterprise computing device. Thus, the enterprise computing device may not interact directly with the user computing device. In some other embodiments, the enterprise computing device may request the updated personal data directly from the user computing device, and the user computing device can respond by transmitting the updated personal data directly to the enterprise computing device.

The method 600 can include transmitting a message notifying the user that the updated personal data has been shared with the enterprise (block 612). The message can be sent to the user computing device to inform the user that the user's updated personal information has been shared with the enterprise.

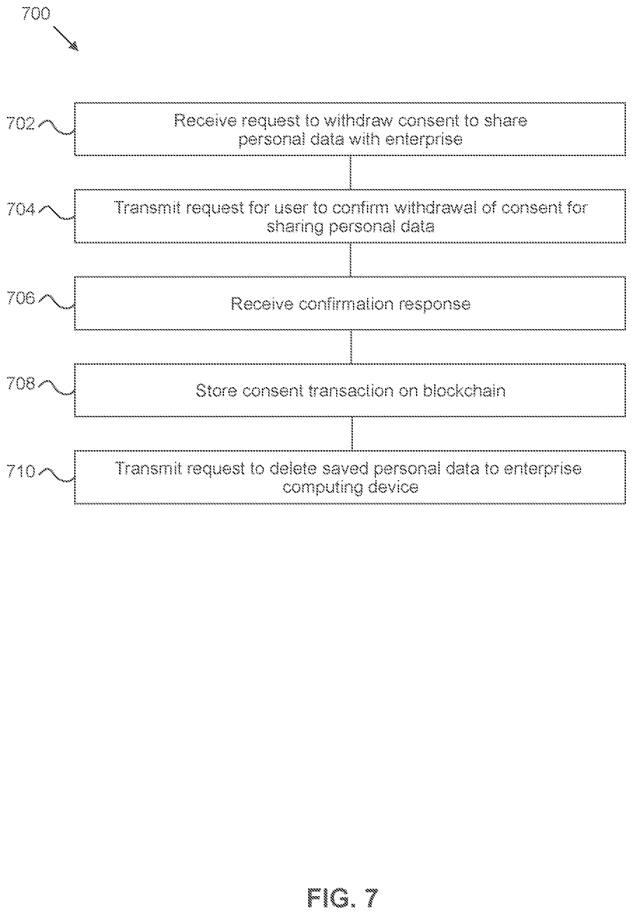

FIG. 7 illustrates a method 700 of withdrawing consent for an enterprise to access personal data, according to an embodiment. In some implementations, the method 700 can be performed by a system such as the personal data management system 400 described above in connection with FIG. 4. In brief overview, the method 700 can include receiving a request to withdraw consent to share personal data with an enterprise (block 702), transmitting a request for the user to confirm withdrawal of consent for sharing the updated personal data (block 704), and receiving a confirmation response (block 706). The method 700 can also include storing a consent transaction on a blockchain (block 708) and transmitting a request to delete saved personal data to an enterprise computing device (block 710).

Referring again to FIG. 7, and in greater detail, the method 700 can include receiving a request to withdraw consent to share personal data with an enterprise (block 702). The request can be received by the personal data management system, for example, from a user computing device. In some embodiments, the user can interact with a mobile application executing on the user computing device to indicate that the user wishes to withdraw consent to share personal information that was previously granted to an enterprise. The mobile application may be configured to generate the request to withdraw consent and to transmit the request to the personal data management system, based on the user interaction. In some embodiments, the request to withdraw consent can be formatted as one or more application programming interface (API) requests. The consent can be represented by or can correspond to a first consent transaction stored on a blockchain network.

The method 700 can include transmitting a request for the user to confirm withdrawal of consent for sharing the updated personal data (block 704). The personal data management system can transmit the confirmation request to the user computing device to cause the mobile application executing on the user computing device to display information corresponding to the confirmation request. The confirmation request can help to ensure that the request to withdraw consent for sharing personal data was not sent to the personal data management system inadvertently.

The method 700 can include receiving a confirmation response (block 706). The confirmation response can be any information that confirms that the consent to share the personal data with the enterprise should be withdrawn. In some embodiments, the user can interact with the mobile application executing on the user computing device to confirm that the user wishes to withdraw consent to share the personal information that was previously granted to the enterprise. The mobile application may be configured to generate the confirmation response and to transmit the confirmation response to the personal data management system, based on the user interaction. In some embodiments, the confirmation response can be formatted as one or more application programming interface (API) requests.

The method 700 can include storing a consent transaction on a blockchain (block 708). The second consent transaction can include the user's unique user identifier, the enterprise's unique enterprise identifier, and information indicating the user's consent to share personal data with the enterprise has been withdrawn. In some embodiments, the consent transaction can include a respective value for each of a plurality of fields. For example, the fields can include any of the fields shown and described above in connection with the example consent transaction data structure of Table 2.

The method 700 can include transmitting a request to delete saved personal data to an enterprise computing device (block 710). The request can be sent to an enterprise computing device associated with the enterprise from which consent for personal data sharing is being withdrawn. In some embodiments, the request can be sent to an enterprise application, such as a CRM application, that executes on the enterprise computing device. The request can be formatted as an API request. In some embodiments, the method 700 can also include transmitting a message indicating that the request to delete the personal data has been sent to the enterprise computing device. The message can be sent to the user computing device to inform the user that the consent for sharing personal data with the enterprise has been successfully withdrawn.

One innovative aspect of the subject matter described in this disclosure can be implemented in a system. The system can include a user management node. The user management node can be configured to transmit, to a user computing device, a prompt requesting a user to register for sharing personal data with an enterprise. The user management node can be configured to receive, from the user computing device, a response to the prompt, the response indicating that the user will register for sharing the personal data with the enterprise. The user management node can be configured to generate a unique user identifier associated with an email address of the user. The user management node can be configured to transmit, to the user computing device, a user public key and a user private key for managing encryption of the personal data on the user computing device. The user management node can be configured to receive, from the user computing device, consent data indicating that the user consents to share the personal data with the enterprise. The user management node can be configured to store, on a blockchain network, a consent transaction, a personal data update transaction, and an entry of a consent ledger corresponding to the consent data. Each of the consent transaction, the personal data update transaction, and the entry of the consent ledger can include the unique user identifier. The system can also include an enterprise management node. The enterprise management node can be configured to transmit, to an enterprise computing device, an enterprise public key and an enterprise private key. The enterprise management node can be configured to validate, based on the entry of the consent ledger, that the user has consented to share the personal data with the enterprise. The enterprise management node can be configured to fetch the personal data encrypted with the user public key. The enterprise management node can be configured to transmit, to the enterprise computing device associated with the enterprise, the encrypted personal data. The system can also include a notification node configured to generate a message indicating that the personal data has been shared with the enterprise. The notification node can also be configured to transmit the message to the user computing device.

In some embodiments, the user management node can be further configured to communicate with a mobile application executing on the user computing device via a first API. The enterprise management node can be further configured to communicate with an enterprise application executing on the enterprise computing device via a second API. In some embodiments, the user management node can be further configured to transmit, to the user computing device, a URL corresponding to a download link for the mobile application. In some embodiments, at least one of the first API and the second API can be a REST API. In some embodiments, the enterprise application executing on the enterprise computing device can be a CRM application. In some embodiments, the personal information can include at least one of a first name, a last name, an address, a city, a region, a country, a postal code, the email address, a phone number, or a credit card number.

In some embodiments, the system can also include an event bus communicatively coupling each of the user management node, the enterprise management node, and the notification management node with the blockchain network. In some embodiments, the enterprise management node can be further configured to fetch the personal data encrypted with the user public key via a first communication link coupling the enterprise management node with the event bus, a second communication link coupling the event bus with the user management node, and a third communication link coupling the user management node with the user computing device.

In some embodiments, the blockchain network can include a plurality of blockchain nodes each storing a respective copy of the consent transaction and the personal data update transaction. In some embodiments, the user management node can be further configured to generate each of the consent transaction, the personal data update transaction, and the entry of the consent ledger without including any personally identifiable information associated with the user.

In some embodiments, the user management node can be further configured to receive, from the user computing device, a request to withdraw consent to share the personal data with the enterprise. The user management node can also be configured to store, on the blockchain network, a second consent transaction indicating that the consent to share the personal data with the enterprise has been withdrawn. The second consent transaction can include the unique user identifier.

Another innovative aspect of the subject matter described in this disclosure can be implemented in a method. The method can include transmitting, by a personal data management system to a user computing device, a request for a user to register for sharing personal data with an enterprise. The method can include receiving, by the personal data management system from the user computing device, a response to the request. The response can indicate that the user will register for sharing the personal data with the enterprise. The method can include generating, by the personal data management system, a one-time token for account verification. The method can include transmitting, by the personal data management system to the user computing device, a first URL associated with the one-time token. The method can include determining, by the personal data management system, that the user is verified by detecting that the URL was selected on the user computing device. The method can include creating, by the personal data management system, a unique user identifier associated with an email address of the user. The method can include transmitting, by the personal data management system to the user computing device, an information package. The information package can include a second URL corresponding to a download link for a mobile application. The mobile application can be configured to allow the user to store the personal data on the user computing device. The information package can also include a public-private key pair for managing encryption of the personal data on the user computing device.

In some embodiments, the method can also include receiving, by the personal data management system from the user computing device, consent data indicating that the user consents to share the personal data with the enterprise. The method can include storing, by the personal data management system on a blockchain network, a consent transaction, a personal data update transaction, and an entry of a consent ledger. Each of the consent transaction, the personal data update transaction, and the entry of the consent ledger can include the unique user identifier.

In some embodiments, the method can include generating, by the personal data management system, the consent transaction including a respective value for each of a plurality of fields. The fields can include at least a transaction timestamp, a unique enterprise identifier corresponding to the enterprise, an event type, at least one attribute type, and a version number. In some embodiments, the method can include generating, by the personal data management system, the personal data update transaction including a respective value for each of a plurality of fields. The fields can include at least a transaction timestamp, at least one attribute type, and a version number. In some embodiments, the method can include generating, by the personal data management system, the entry of the consent ledger including the consent data most recently received from the user computing device.

Another innovative aspect of the subject matter described in this disclosure can be implemented in a method. The method can include receiving, by a personal data management system from a user computing device, a request to withdraw consent to share personal data with an enterprise. The consent can be represented by a first consent transaction stored on a blockchain network. The method can include transmitting, by the personal data management system to the user computing device, a request for the user to confirm that the consent to share the personal data with the enterprise should be withdrawn. The method can include receiving, by the personal data management system from the user computing device, a confirmation that the consent to share the personal data with the enterprise should be withdrawn. The method can include storing, by the personal data management system, on the blockchain network, a second consent transaction indicating that the consent to share the personal data with the enterprise has been withdrawn. The second consent transaction can include the unique user identifier. The method can include transmitting, by the personal data management system to an enterprise computing device, a request to delete a copy of the personal data stored by the enterprise computing device.

In some embodiments, transmitting the request to delete the copy of the personal data stored by the enterprise computing device can include transmitting, by the personal data management system, an API request to an enterprise application executing on the enterprise computing device. In some embodiments, the method can further include transmitting, by the personal data management system to the user computing device, a message indicating that the request to delete the personal data has been sent to the enterprise computing device. In some embodiments, the personal information can include at least one of a first name, a last name, an address, a city, a region, a country, a postal code, the email address, a phone number, or a credit card number.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e., methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. A system, comprising:
a user management node configured to:
transmit, to a user computing device, a prompt requesting a user to register for sharing personal data with an enterprise;
receive, from the user computing device, a response to the prompt, the response indicating that the user will register for sharing the personal data with the enterprise;
generate a unique user identifier associated with an email address of the user;
transmit, to the user computing device, a user public key and a user private key for managing encryption of the personal data on the user computing device;
receive, from the user computing device, consent data indicating that the user consents to share the personal data with the enterprise; and
store, on a blockchain network, a consent transaction, a personal data update transaction, and an entry of a consent ledger corresponding to the consent data, each of the consent transaction, the personal data update transaction, and the entry of the consent ledger comprising the unique user identifier;
an enterprise management node configured to:
transmit, to an enterprise computing device, an enterprise public key and an enterprise private key;
validate, based on the entry of the consent ledger, that the user has consented to share the personal data with the enterprise;
fetch the personal data encrypted with the user public key; and
transmit, to the enterprise computing device associated with the enterprise, the encrypted personal data; and
a notification node configured to:
generate a message indicating that the personal data has been shared with the enterprise; and
transmit the message to the user computing device.

2. The system of claim 1, wherein:
the user management node is further configured to communicate with a mobile application executing on the user computing device via a first application programming interface (API); and
the enterprise management node is further configured to communicate with an enterprise application executing on the enterprise computing device via a second API.

3. The system of claim 2, wherein the user management node is further configured to transmit, to the user computing device, a uniform resource locator (URL) corresponding to a download link for the mobile application.

4. The system of claim 2, wherein at least one of the first API and the second API comprises a representational state transfer (REST) API.

5. The system of claim 2, wherein the enterprise application executing on the enterprise computing device comprises a customer relationship management (CRM) application.

6. The system of claim 1, wherein the personal information comprises at least one of a first name, a last name, an address, a city, a region, a country, a postal code, the email address, a phone number, or a credit card number.

7. The system of claim 1, further comprising an event bus communicatively coupling each of the user management node, the enterprise management node, and the notification management node with the blockchain network.

8. The system of claim 7, wherein the enterprise management node is further configured to fetch the personal data encrypted with the user public key via a first communication link coupling the enterprise management node with the event bus, a second communication link coupling the event bus with the user management node, and a third communication link coupling the user management node with the user computing device.

9. The system of claim 1, wherein the blockchain network comprises a plurality of blockchain nodes each storing a respective copy of the consent transaction and the personal data update transaction.

10. The system of claim 1, wherein the user management node is further configured to generate each of the consent transaction, the personal data update transaction, and the entry of the consent ledger without including any personally identifiable information associated with the user.

11. The system of claim 1, wherein the user management node is further configured to:
receive, from the user computing device, a request to withdraw consent to share the personal data with the enterprise; and
store, on the blockchain network, a second consent transaction indicating that the consent to share the personal data with the enterprise has been withdrawn, the second consent transaction comprising the unique user identifier.

12. A method, comprising:
transmitting, by a personal data management system to a user computing device, a request for a user to register for sharing personal data with an enterprise;
receiving, by the personal data management system from the user computing device, a response to the request, the response indicating that the user will register for sharing the personal data with the enterprise;
generating, by the personal data management system, a one-time token for account verification;
transmitting, by the personal data management system to the user computing device, a first uniform resource locator (URL) associated with the one-time token;
determining, by the personal data management system, that the user is verified by detecting that the URL was selected on the user computing device;
creating, by the personal data management system, a unique user identifier associated with an email address of the user; and
transmitting, by the personal data management system to the user computing device, an information package comprising:
a second URL corresponding to a download link for a mobile application, the mobile application configured to allow the user to store the personal data on the user computing device; and
a public-private key pair for managing encryption of the personal data on the user computing device.

13. The method of claim 12, further comprising:
receiving, by the personal data management system from the user computing device, consent data indicating that the user consents to share the personal data with the enterprise; and
storing, by the personal data management system on a blockchain network, a consent transaction, a personal data update transaction, and an entry of a consent ledger, each of the consent transaction, the personal data update transaction, and the entry of the consent ledger comprising the unique user identifier.

14. The method of claim 13, further comprising generating, by the personal data management system, the consent transaction including a respective value for each of a plurality of fields, the fields comprising at least a transaction timestamp, a unique enterprise identifier corresponding to the enterprise, an event type, at least one attribute type, and a version number.

15. The method of claim 13, further comprising generating, by the personal data management system, the personal data update transaction including a respective value for each of a plurality of fields, the fields comprising at least a transaction timestamp, at least one attribute type, and a version number.

16. The method of claim 13, further comprising generating, by the personal data management system, the entry of the consent ledger including the consent data most recently received from the user computing device.

17. A method, comprising:
receiving, by a personal data management system from a user computing device, a request to withdraw consent to share personal data with an enterprise, wherein the consent is represented by a first consent transaction stored on a blockchain network;
transmitting, by the personal data management system to the user computing device, a request for the user to confirm that the consent to share the personal data with the enterprise should be withdrawn;
receiving, by the personal data management system from the user computing device, a confirmation that the consent to share the personal data with the enterprise should be withdrawn;
storing, by the personal data management system, on the blockchain network, a second consent transaction indicating that the consent to share the personal data with the enterprise has been withdrawn, the second consent transaction comprising the unique user identifier; and
transmitting, by the personal data management system to an enterprise computing device, a request to delete a copy of the personal data stored by the enterprise computing device.

18. The method of claim 17, wherein transmitting the request to delete the copy of the personal data stored by the enterprise computing device further comprises transmitting, by the personal data management system, an application programming interface (API) request to an enterprise application executing on the enterprise computing device.

19. The method of claim 17, further comprising transmitting, by the personal data management system to the user computing device, a message indicating that the request to delete the personal data has been sent to the enterprise computing device.

20. The method of claim 17, wherein the personal information comprises at least one of a first name, a last name, an address, a city, a region, a country, a postal code, the email address, a phone number, or a credit card number.
